(19) United States
(12) Patent Application Publication
(10) Pub. No.: US 2012/0084378 A1
(43) Pub. Date: Apr. 5, 2012

(54) Communication system, master node, and slave node

(75) Inventors: Naoji Kaneko, Toyokawa-shi (JP); Tomohisa Kishigami, Obu-shi (JP)

(73) Assignee: DENSO CORPORATION, Kariya-city (JP)

(21) Appl. No.: 13/200,738

(22) Filed: Sep. 29, 2011

(30) Foreign Application Priority Data
Oct. 1, 2010 (JP) 2010-224214

(51) Int. Cl. G06F 15/16

(52) U.S. Cl. 709/208

(57) ABSTRACT

A slave node communicably coupled to a master node via a bus determines determine whether an active communication mode or a passive communication mode is started based on a header transmitted from the master node. The slave node transmits the header and an ID subsequent to the header when it is determined that the active communication mode is started based on the received header. The ID requests active transmission of a response required to be transmitted in the active communication mode upon the slave node having the response. The slave node monitors arbitration on a bus, and transmits the response subsequent to the ID when the slave node wins the arbitration on the bus between the ID transmitted from the slave node and another information transmitted from another slave node communicably coupled to the master node via the bus based on a result of the monitor.

### CROSS REFERENCE TO RELATED APPLICATIONS

This application is based on Japanese Patent Application 2010-224214 filed on Oct. 1, 2010. This application claims the benefit of priority from the Japanese Patent Application, so that the descriptions of which are all incorporated herein by reference.

### TECHNICAL FIELD

The present disclosure relate to communication systems combine a passive communication mode and an active communication mode. In the passive communication mode, a slave node designated by a master node sends data, and in the active communication mode, slave nodes actively send data.

### BACKGROUND

There are well-known master-slave communication protocols. In accordance with a master-slave communication protocol as a typical example of the master-slave communication protocols, a master node transmits a header with an ID, and a slave node, which is associated with the ID of the header, transmits data as a response to a network; the set of the header and corresponding response is communicated through the network as a frame. A master node will be referred to simply as a master, and a slave node will be referred to simply as a slave.

In the master-slave communication protocol, a slave passively sends data when only receiving a corresponding one of headers sent from a master in accordance with a predetermined schedule. For the master-slave communication protocol, if an event occurs in a slave, there is a requirement to immediately inform another node of the event. In order to meet such a requirement, installation, in a master-slave communication protocol, of a mechanism has been proposed; the mechanism allows slaves to actively transmit data without waiting for data sending timings in accordance with schedules predetermined by masters.

For example, in LIN (Local Internet Network) protocol, as an example of these master-slave communication protocols, which is applied for in-vehicle networks, headers for event-triggered frames are prepared in addition to headers for unconditional frames. A header of an event-triggered frame causes a slave detecting the occurrence of an event to transmit, via a LIN bus, a response, and a header of an unconditional frame causes a slave identified by the header to transmit, via the LIN bus, a response.

Specifically, in the LIN protocol, when detecting the occurrence of an event, a slave is triggered to send a response using an event triggered frame (see “DETAILED DESCRIPTION OF VEHICLE NETWORK SYSTEM”, MICHIO SATO, published on Dec. 1, 2005, CQ PUBLISHING CO., LTD).

In addition, the following communication method is disclosed in Japanese Patent Application Publication NO. 2007-066111. In the communication method, pieces of output data from a master are collectively transferred via a bus to slaves in a single OUT frame, and pieces of input data from the slaves are replied in their IN frames at their non-overlappedly allocated time slots to the master via the bus. This can implement regular communications between the master and the slaves.

Additionally, in the communication method, when the master identifies, in an OUT frame, one or more slaves that the master wants to check for whether there are messaging requirements therein, and the identified one or more slaves reply a response frame indicative of messaging requirements, the master transmits a messaging allowance frame to at least one slave that has replied the response, thus passing, to the at least one slave, authority to the bus. This results in that the at least one slave with the authority to the bus can transmit messages to the master. That is, the communication method disclosed in the Patent Publication allows each slave to actively transmit data to, for example, the master.

### SUMMARY

In the LIN protocol, the header, referred to as an event header, of an event-triggered frame can be associated with slaves, which is different from the header of an unconditional frame; the header of an unconditional frame is associated with a single slave. For this reason, as illustrated in FIG. 10, if a slave _1 and a slave _2, both of which are associated with the event header “H” of the ID “0x10 (hex 10)” and they simultaneously send responses “R” when events occur in the slaves _1 and _2, there is a collision between these responses R. Note that, in FIG. 10, the ID of “0x10” is used as the common event header for the slaves _1 and _2, and IDs of “0x20” and “0x30” are used for uniquely identifying the respective slaves _1 and _2 for unconditional frames (for polling of the slaves _1 and _2). 1 SLOT (FLAME SLOT) represents time allocated for sending one frame (header and response) through the LIN bus.

If a collision between the responses R from the slaves _1 and _2 is detected in the corresponding slot (the first slot at the collision), the colliding responses R are discarded, and the master transmits, to one of the corresponding slaves _1 and _2, such as the slave _1, the header (ID of “0x20” identifying the slave _1 that should respond it in the following second slot, and transmits, to the other of the corresponding slaves _1 and _2, such as the slave _2, the header (ID of “0x30” identifying the slave _2 that should respond it in the following third slot.

However, the aforementioned method for addressing a collision between responses from slaves requires corresponding colliding slaves to successively send their responses. This may result in a reduction of communication efficiency in communications using the LIN protocol.

In addition, in order to allow a slave to actively send data to the master, the communication method disclosed in the Patent Publication NO. 2007-066111 requires:

the sending of an OUT frame from the master to a specified slave;

the sending of a response frame from the specified slave to the master; and

the sending of a messaging allowance frame from the master to the specified slave.

In other words, the communication method disclosed in the Patent Publication NO. 2007-066111 allows a slave to actively send data to the master only when these three frames (OUT frame, response frame, and messaging allowance frame) have been communicated.

Thus, the communication method disclosed in the Patent Publication NO. 2007-066111 makes complicated the communication procedure to allow a slave to actively send data to the master. This may result in both: a reduction of communication efficiency in communications on the bus using the communication method, and a difficulty to immediately inform the master of the occurrence of an event.

In view of the circumstances set forth above, one aspect of the present disclosure seeks to provide communication systems each comprised of a master node and a plurality of slave nodes communicably coupled to the master node via a bus, which are designed to address at least one of the problems set forth above.

Specifically, an alternative aspect of the present disclosure aims to provide such communication systems capable of actively sending data from a slave node immediately with higher communication efficiency.

In addition, a further aspect of the present disclosure aims to provide a master node communicably coupled to a plurality of slave nodes via a bus; the master allows a slave to actively send data immediately with higher communication efficiency. A still further aspect of the present disclosure seeks to provide a slave node communicably coupled to a master node via a bus; the slave node is capable of actively sending data immediately with higher communication efficiency.

According to one aspect of the present disclosure, there is provided a communication system including a bus; a master node; and a plurality of slave nodes communicably coupled to the master node through the bus. The master node is configured to transmit any one of: first information indicative of start of an active communication mode; and second information including at least designation of one of the plurality of slave nodes as a target slave node requested to send data in a passive communication mode. Each of the plurality of slave nodes is configured to: receive any one of the first information and second information transmitted from the master node; determine whether the active communication mode or the passive communication mode is started based on any one of the first information and second information received thereby; and transmit the first information and third information subsequent to the first information when it is determined that the active communication mode is started based on the first information received thereby. The third information requests active transmission of data required to be transmitted in the active communication mode upon a corresponding slave node having the data. Each of the plurality of slave nodes is also configured to transmit the data subsequent to the third information when the corresponding slave node wins arbitration on the bus between the third information transmitted from the corresponding slave node and the third information transmitted from an alternative slave node in the plurality of slave nodes upon the third information being transmitted from the alternative slave node, and transmit the designation and data subsequent to the designation when it is determined that the passive communication mode is started based on the second information received thereby and the designation designates the corresponding slave node as the target node.

The communication system according to the one aspect of the present disclosure allows each slave node to determine whether there is timing for starting the passive communication mode or timing for starting the active communication mode based on the first information or the second information transmitted from the master node. This configuration eliminates the need of communications between the master node and each of the slave nodes using specific frames for switching between the passive communication mode and the active communication mode. Thus, if there is a need for a slave node to actively transmit data, the slave node can immediately inform the master node and/or another slave node of the data.

In addition, the communication system according to the one aspect of the present disclosure is configured such that, if some slave nodes request to transmit data, that is, transmit the third information in the active communication mode, arbitration on the bus among pieces of the third information transmitted from these slave nodes allows only one of these slave nodes, which winds the arbitration on the bus, to transmit the data on the bus. Thus, it is possible to efficiently transmit active data from each slave node without increasing traffic on the bus.

Note that, as the designation of one of the plurality of slave nodes, an ID of the one of the plurality of slave nodes or an ID of a message included in the one of the plurality of slave nodes can be used.

In a preferred embodiment of the one aspect of the present disclosure, the first information is designation of the start of the active communication mode, and the master node is configured to transmit the second information including only the designation of one of the plurality of slave nodes as the target slave node in the passive communication mode. This preferred embodiment reduces the length of the second information including only the designation of one of the plurality of slave nodes as compared with the length of the second information including a set of start of the passive communication mode and the designation of one of the plurality of slave nodes. This makes it possible to more improve communication efficiency on the bus.

In a preferred embodiment of the one aspect of the present disclosure, the arbitration on the bus between the third information transmitted from the corresponding slave node and the third information transmitted from the alternative slave node is configured such that one of the corresponding slave node and the alternative slave node wins when the one of the corresponding slave node and the alternative slave node starts to transmit the third information earlier than the other thereof.

In a preferred embodiment of the one aspect of the present disclosure, the bus allows a bit with an electrical dominant level to be asserted thereon in priority to a bit with an electrical recessive level different from the electrical dominant level, the third information is comprised of a train of bits, the bits being comprised of at least one the dominant level and at least one the recessive level, and the arbitration on the bus between the third information transmitted from the corresponding slave node and the third information transmitted from the alternative slave node is configured such that one of the corresponding slave node and the alternative slave node wins when the train of bits as the third information transmitted from the one of the corresponding slave node and the alternative slave node remains unchanged in comparison to the train of bits as the third information transmitted from the other thereof.

According to another aspect of the present disclosure, there is provided a master node communicably coupled to a plurality of slave nodes through a bus. The master node includes a first transmitting unit configured to transmit first information indicative of start of an active communication mode for requesting at least one of the plurality of slave nodes to actively transmit data upon the at least one of the plurality of slave nodes having the data; a second transmitting unit configured to transmit second information including at least designation of one of the plurality of slave nodes as a target slave node requested to send data in a passive communication mode; and an activating unit configured to switchably activate any one of the first and second transmitting units in accordance with a previously established schedule.

According to a further aspect of the present disclosure, there is provided a slave node communicably coupled to a master node through a bus. The slave node includes a receiving unit configured to, when any one of first information indicative of start of an active communication mode and second information including at least designation of the slave node as a target slave node requested to send data in a passive communication mode is transmitted, receive any one of the first information and the second information transmitted from the master node. The slave node includes a determining unit configured to determine whether the active communication mode or the passive communication mode is started based on any one of the first information and second information received by the receiving unit, and a first transmitting unit configured to transmit the first information and third information subsequent to the first information when it is determined that the active communication mode is started based on the first information received by the receiving unit, the third information requesting active transmission of data required to be transmitted in the active communication mode upon the slave node having the data. The slave node includes a bus monitoring unit configured to monitor arbitration on the bus, a second transmitting unit configured to transmit the data subsequent to the third information when the slave node wins the arbitration on the bus between the third information transmitted from the slave node and another information transmitted from another slave node communicably coupled to the master node based on a result of the monitor by the bus monitoring unit, and a third transmitting unit configured to transmit the designation and data subsequent to the designation when it is determined that the passive communication mode is started based on the second information received by the receiving unit and the designation designates the slave node as the target node.

The above and/or other features, and/or advantages of various aspects of the present disclosure will be further appreciated in view of the following description in conjunction with the accompanying drawings. Various aspects of the present disclosure can include and/or exclude different features, and/or advantages where applicable. In addition, various aspects of the present disclosure can combine one or more feature of other embodiments where applicable. The descriptions of features, and/or advantages of particular embodiments should not be constructed as limiting other embodiments or the claims.

### BRIEF DESCRIPTION OF THE DRAWINGS

Other aspects of the present disclosure will become apparent from the following description of an embodiment with reference to the accompanying drawings in which:

FIG. 1 is a circuit diagram schematically illustrating an example of the overall structure of a communication system according to a first embodiment of the present disclosure;

FIG. 2 is a view schematically illustrating the structure of a frame to be used in the communication system, the structure of data to be communicated between a microcomputer and a transceiver of the communication system, and the structure of encoded data according to the first embodiment;

FIG. 3 is a flowchart schematically illustrating a master task to be carried out by the microcomputer of a master of the communication system according to the first embodiment;

FIG. 4 is a flowchart schematically illustrating a slave task to be carried out by the microcomputer of a master or a slave of the communication system according to the first embodiment;

FIG. 5 is a flowchart schematically illustrating an event-frame transmission routine to be executed by the microcomputer in step S390 of FIG. 4;

FIG. 6 is a timing chart schematically illustrating basic operations of the communication system according to the first embodiment;

FIG. 7 is a timing chart schematically illustrating operations of the communication system according to the first embodiment if some slaves want to transmit their prepared responses in a slot for an event frame;

FIG. 8 is a timing chart schematically illustrating operations of the communication system according to a modification of the first embodiment;

FIG. 9 is a timing chart schematically illustrating an example of the structure of frames to be used for data communications of a communication system according to a second embodiment of the present disclosure, and basic operations of the communication system according to the second embodiment; and

FIG. 10 is a timing chart schematically illustrating basic operations of a conventional communication system.

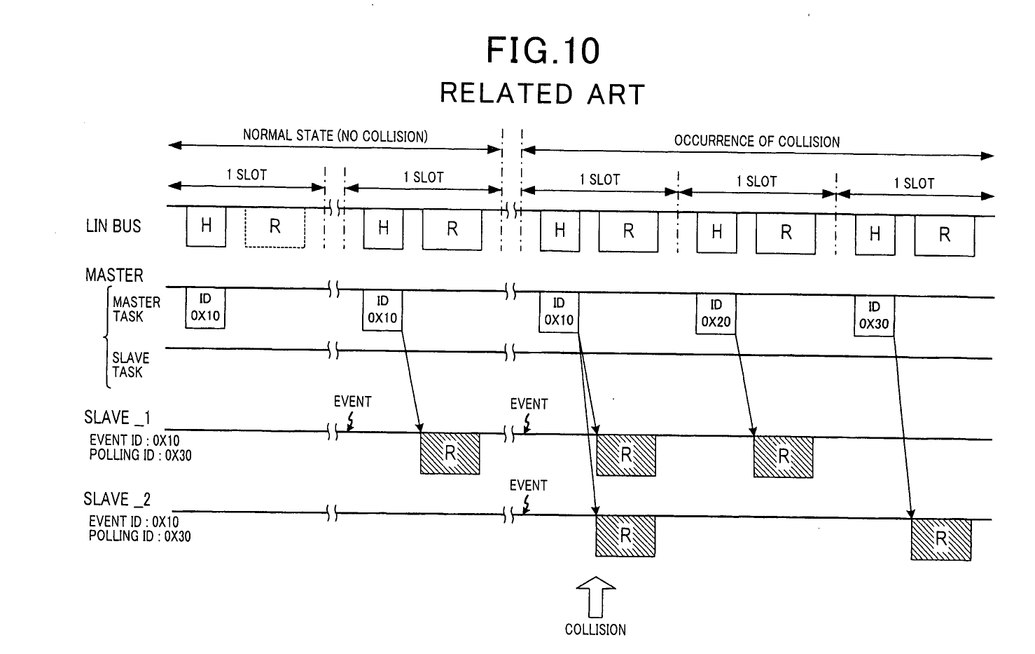

### DETAILED DESCRIPTION OF EMBODIMENT

Embodiments of the present disclosure will be described hereinafter with reference to the accompanying drawings. In the embodiments, like parts between the embodiments, to which like reference characters are assigned, are omitted or simplified in redundant description.

### First Embodiment

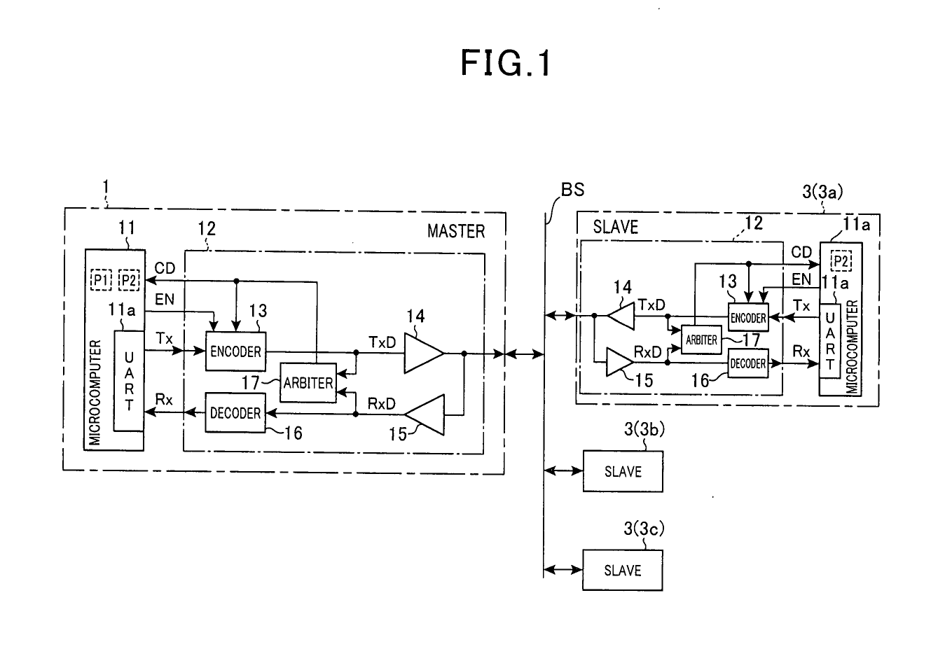

An example of the overall structure of a communication system for vehicles is illustrated in FIG. 1; to the communication system, a preselected master-slave communication protocol, such as LIN protocol, is applied.

The communication system includes a master node 1, a plurality of slave nodes 3 (3a, 3b, 3c, . . . ) to be controlled by the master node 1, and a bus BS through which the master node 1 is communicably coupled to the slave nodes 3. Note that a node is, for example, a hardware computing terminal or a software module.

For example, in the first embodiment, the slave nodes 3 are installed in plural types of target devices; these plural types of target devices are provided in a target vehicle for detecting the operating conditions of the target vehicle, controlling them and/or actuating corresponding parts of the target vehicle.

The master node 1 is operative to communicate with the slave nodes 3 via the bus BS to thereby obtain the operating conditions of the target vehicle, and/or instruct the slaves 3 to control and/or actuate the corresponding target devices for control of the target vehicle. The master node 1 will be referred to simply as the master 1, and the slave nodes 3 will be referred to simply as the slaves 3.

In this embodiment, the master 1 consists of an electronic control unit ECU) communicably coupled to an in-vehicle network to which a CAN (Controller Area Network) protocol is applied. The master 1 according to this embodiment is operative to carry out automotive-body applications of the target vehicle. For example, if the master 1 is an ECU for controlling door applications of the target vehicle, control/actuate devices for automotive-body parts, such as mirrors, door locks, windows, and so on can be used as the target devices installed with the slaves 3 (3a, 3b, 3c, . . . ).

Note that a plurality of masters 1 can be provided in the target vehicle; each of these masters 1 can control a corresponding plurality of slaves 3. As the target devices installed with the slaves 3, control/actuate devices for other automobile parts, such as sunroofs, wipers, air conditioners, steering, lights, and so on can be used.

The master 1 and the slaves 3 according to this embodiment operate in accordance with the preselected master-slave protocol. In the master-slave protocol, the master 1 is designed to communicate with the slaves 3 using frames each of which is a unit of data to be transmitted and received via the bus BS.

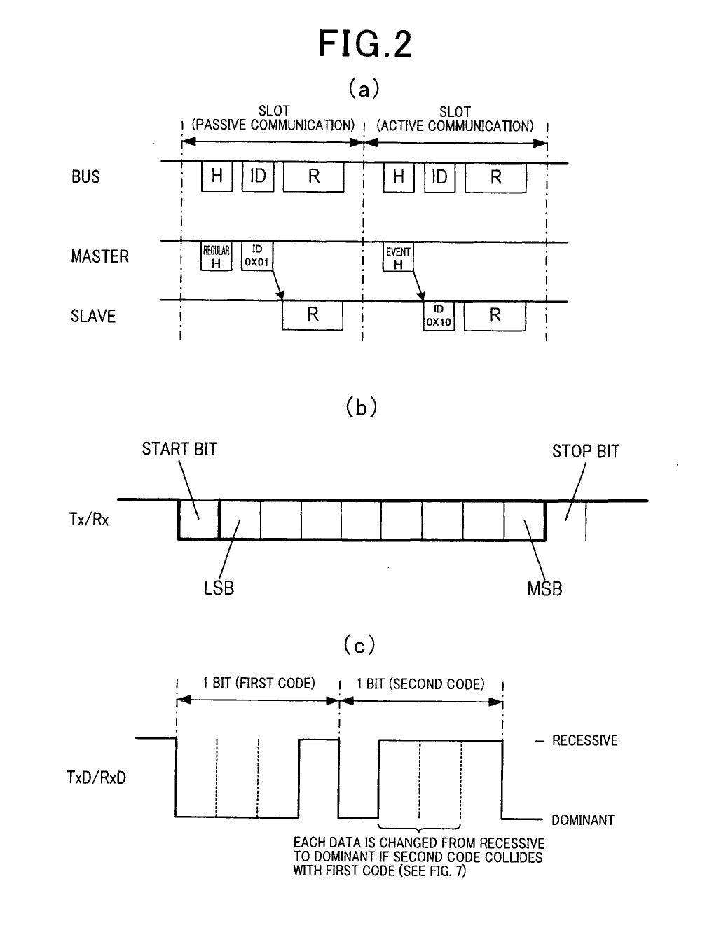

(a) of FIG. 2 schematically illustrates the structure of a frame according to this embodiment.

In the preselected master-slave protocol, the master 1 operates in a first communication mode to successively designate the slaves 3, in other words, performs polling of the slaves 3, and each designated slave 3 operates in the first communication mode to send a response (data). Because each slave 3 sends a response only after it is specified by the master 1, this first communication mode will be referred to as a “passive communication mode”. On the other hand, each slave 3 operates in a second communication mode to actively send data during a period specified by the master 1. Because each slave 3 actively sends data independently of a corresponding designation by the master 1, this second communication mode will be referred to as an “active communication mode”.

As illustrated in (a) of FIG. 2, in the passive communication mode, the master 1 successively sends a header (H) specifying the type of communication mode, that is, the passive communication mode, and an ID designating a slave 3 requested by the master 1 to reply a response. The header and ID are successively received by the slaves 3 via the bus BS. A slave 3, whose ID is not matched with the received ID, outputs the received header and ID (or a received frame described later) without sending any response. Otherwise, a slave 3 whose ID is matched with the received ID sends the header and ID, and sends a response after the ID. As a result, data is sent through the bus BS as a frame (message frame) containing the set of the header, the ID, and the response. One slot is allocated for one frame on the bus BS and required for passing the one frame.

On the other hand, in the active communication, as illustrated in (a) of FIG. 2, the master 1 sends only a header (H) specifying the type of communication mode, that is, the active communication. The header is received by the slaves 3 via the bus BS. If a slave 3, which wants to send data, successively sends the received header and its ID, and if the slave 3 wins bus arbitration based on the ID, the slave 3 sends data following the ID.

Note that an ID is a number allocated to a corresponding slave 3 for unique identification thereof, but allocated to corresponding data for unique identification thereof.

The active communication is used in cases where it is necessary for a slave 3 to immediately inform the master 1 that the state of a corresponding target device is changed due to the driver's operation, such as open or close of a corresponding door as the occurrence of an event (an event trigger).

Hereinafter, frames to be used in the passive communication mode will be referred to as regular frames (REGULAR H in (a) of FIG. 2), and frames to be used in the active communication will be referred to as event frames (EVENT H in (a) of FIG. 2). A notification using an event frame will be referred to simply as an event.

Next, an example of the overall structure of each node, in other words, each of the master 1 and a slave 3 will be described.

Referring to FIG. 1, the master 1 is comprised of a microcomputer 11 and a transceiver 12. The microcomputer 11 is communicable with the transceiver 12, and operative to carry out tasks to communicate with slaves 3 and other ECUs. The transceiver 12 is connected with the bus BS, and operative to: encode data Tx provided from the microcomputer 11 into transmit data TxD; output the transmit data TxD to the bus BS; receive data (received data) RxD on the bus BS; decode the received data RxD into data Rx; and input the decoded data Rx to the microcomputer 11.

The transceiver 12 is operative to generate a collision detection signal CD with a preset active level (high level or low level) to feed it to the microcomputer 11 when transmit data TxD outputted from the local node is rewritten on the bus BS, in other words, the transmit data TxD loses bus arbitration upon collision between the transmit data TxD and output data from another node.

On the other hand, a slave 3 has a substantially identical structure of the master 1 except that some tasks to be carried out by the microcomputer 3 of the slave 3 are different from those to be carried out by the microcomputer 3 of the master 1.

Note that each slave 3 is operative to run a corresponding slave task that controls the sending of data (a response) in accordance with the type of a header sent from the master 1.

The master 1 is operative to run a master task that controls, in accordance with a previously established schedule, switching between the sending of the set of a header and an ID in one or more regular frames and the sending of a header in one or more event frames, thus controlling communications on the bas BS. The master 1 is also operative to run a slave task identical to the slave task of each slave 3 in order to allow the master 1 to send data (a response) during the running of the slave task.

The microcomputer 11 is comprised of a UART (Universal Asynchronous Receiver Transmitter) 11a in addition to a common main module 11b including a CPU, a ROM, a RAM, an IO port, and one or more peripherals; this UART 11a is operative to carry out serial start-stop communications (serial asynchronous communications). The UART 11a can be designed as a hardware circuit or a software module.

The UART 11a uses NRZ (Non-Return to Zero) code. Specifically, each of data Tx to be transmitted from the UART 11a and data Rx to be received thereinto consists of a logical low start bit with one-bit length, a configurable number of data bits (8 bits in this embodiment), and one or more logical high stop bits (one stop bit in this embodiment). The start bit represents the start of the corresponding data Tx/Rx, and the stop bit represents the stop of the corresponding data Tx/Rx. That is, each of data Tx and data Rx according to this embodiment is designed as 10-bit block data. The first data bit of the 8-bit data as the main part of data Tx or Rx is the least significant bit (LSB), and the last data bit thereof is the most significant bit (MSB).

In this embodiment, each of headers and IDs is comprised of 10-bit block data transmittable or receivable by the UART 11a at a time, and each response is comprised of a predetermined number of, such as one or more, pieces of block data.

The transceiver 12 is comprised of an encoder 13, a transmit buffer 14, a receive buffer 15, a decoder 16, and an arbiter 17.

The encoder 13 is operative to encode data Tx in NRZ code supplied from the microcomputer 11 into transmit data TxD in code used on the bus BS. The transmit buffer 14 is operative to transmit the transmit data TxD encoded by the encoder 13 to the bus BS, and the receive buffer 15 is operative to capture data in PWM code on the bus BS as received data RxD. The decoder 16 is operative to decode the received data RxD in PWM code into data Rx, and feed the decoded data Rx to the microcomputer 11. The arbiter 17 is operative to output a collision detection signal CD if the transmit data TxD sent from the encoder 13 and the received data RxD is mismatched in level with each other.

The receive buffer 15 is designed as, for example, a common comparator, and operative to output the logical high level if the level on the bus BS is higher than a preset threshold level, and the logical low level if the level on the bus BS is lower than the preset level.

For example, as illustrated in (c) of FIG. 2, the encoder 13 is operative to:

divide the length of each bit of data Tx into quarters;

convert a corresponding bit of the data Tx into the first code if the corresponding bit is the logical low level, the first code consists of the logical low levels in the former three-quarters of the corresponding bit, and the logical high level in the later quarter thereof; and

convert the corresponding bit of the data Tx into the second code if the corresponding bit is the logical high level, the second code consists of the logical low level in the former quarter of the corresponding bit, and the logical high levels in the later three-quarters thereof.

That is, the encoder 13 is operative to convert an NRZ code into a PWM code.

In contrast, the decoder 16 is operative to convert the first code of received data RxD into a bit of the logical low level, and convert the second code of the received data RxD into a bit of the logical high level.

That is, the decoder 16 is operative to convert a PWM code into an NRZ code.

In this embodiment, the bus BS has two states (logical levels): dominant state (the logical low level) and recessive state (the logical high level). For example, the dominant (logical low level) corresponds to, for example, a ground level (logical 0), the recessive corresponds to, for example, a level (logical 1) of a battery (not shown), and, in the idle state of the bus BS in which no signals appear on the bus BS, the level on the bus BS is set to the recessive.

Specifically, if signals are simultaneously transmitted from the transmit buffers 14 of nodes, the level on the bus BS is the dominant as long as at least one of the signals has the logical low level (dominant). This structure of the bus BS and the transmit buffer 14 of each node can be implemented using, for example, a single wire, common open-collector circuits, and pull-up resistors.

Particularly, the encoder 13 according to this embodiment is configured to supply transmit data TxD encoded thereby in accordance with data Tx to the transmit buffer 14 upon the collision detection signal CD with the non-active level, and, if the collision detection signal CD is changed to the active level, supply transmit data TxD whose levels are fixed to the high levels (recessives) until an enabling signal EN is inputted from the microcomputer 11 to the encoder 13.

The arbiter 17 is comprised of, for example, an XOR gate, and designed to compare transmit data TxD with received data RxD in bits.

Specifically, on the bus BS, when there is a collision between the first code in first transmit data TxD from a node and the second code in second transmit data TxD from an alternative node, the first code in the first transmit data TxD wins on bus arbitration whereas the second code loses thereon so that the first code is transmitted with the second code is rewritten into the first code. Thus, as a result of the collision, in the alternative node, the collision detection signal CD outputted from the arbiter 17 of the alternative node is changed to the active level because the second code in the second transmit data TxD from the alternative node is mismatched with the first code in the received data RxD captured from the bus BS.

As described above, each slave 3 is comprised of the microcomputer 11 and the transceiver 12 as well as the master 1.

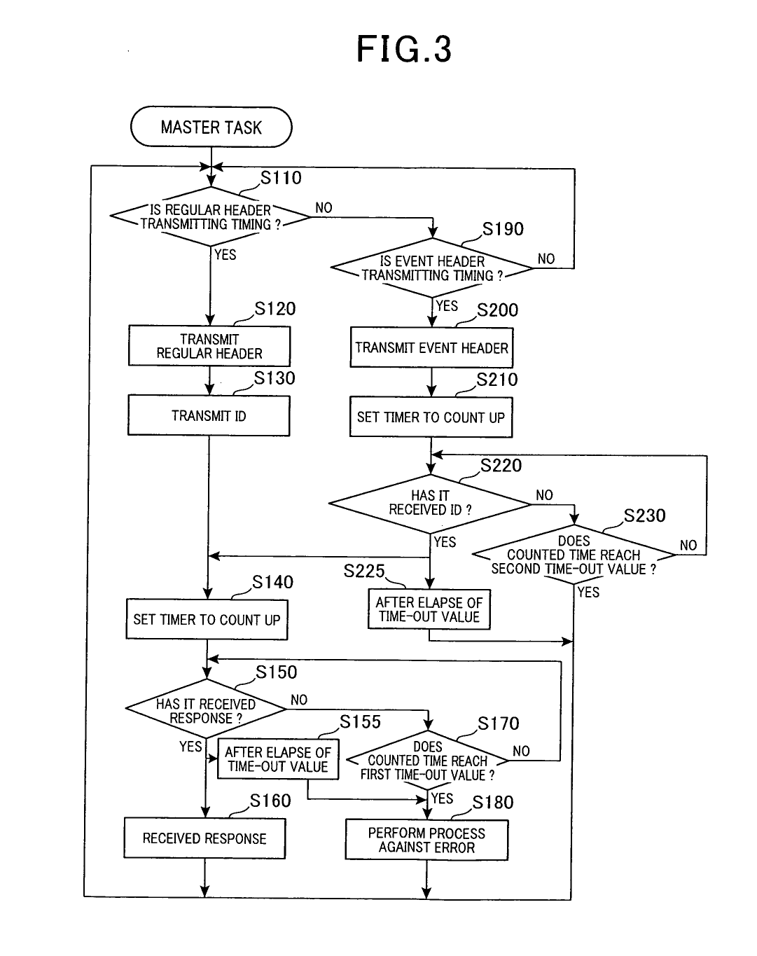

Next, the master task to be carried out by the microcomputer 11 of the master 1 in accordance with a corresponding master-task program P1 stored in the microcomputer 11 will be described hereinafter with reference to FIG. 3.

The master task (master-task program P1) is launched when execution of an initializing process allows the bus BS to be used after the master 1 is powered on.

When the master task is launched, the microcomputer 11 of the master 1 determines whether there is timing for sending a header for a regular frame according to the previously established schedule in step S110; this header will be referred to as a regular header. Upon determining that there is not timing for sending a regular header (NO in step S110), the microcomputer 11 determines whether there is timing for sending a header for an event frame according to the previously established schedule in step S190; this header will be referred to as an event header. Upon determining that there is not timing for sending an event header (NO in step S190), the microcomputer 11 returns to step S110, and repeats the determinations in step S110 and S190 until the determination of any one of steps S110 and S190 is affirmative.

Specifically, in accordance with the previously established schedule, the microcomputer 11 sends any one of a regular header and an event header for each slot allocated for sending a corresponding one frame (header and response). For example, the schedule has been determined such that a regular header and an event header are alternately transmitted from the master 1, or such that one of a regular header and an event header is transmitted every time the other of the regular header and the event header is transmitted at M times.

Upon determining that there is timing for sending a regular header (YES in step S110), the microcomputer 11 transmits the enabling signal EN to the encoder 13, in other words, changes the level of the enabling signal EN from an inactive level to an active level to allow the encoder 13 to output encoded data in step S120. Thereafter, in step S120, the microcomputer 11 sends a regular header specifying the type of communication mode. Subsequently, the microcomputer 11 sends an ID that represents the ID of a slave (a target slave 3 as a target node 3; this target slave 3 is requested by the master 11 to reply a response in step S130.

This results in that 8-bit data indicative of the regular header surrounded by the start and stop bits is transmitted from the UART 11a as data Tx in NRZ code, and thereafter, 8-bit data indicative of the ID of the target slave 3 surrounded by the start and stop bits from the UART 11a as data Tx in NRZ code. The regular header and the ID are successively encoded by the encoder 13 into two pieces of transmit data TxD in PWM code, and the two pieces of transmit data TxD are transmitted to the bus BS through the transmit buffer 14.

At the timing of completion of the sending of the ID, the microcomputer 11 starts to measure time (for example, sets a hardware or software timer to count up) in step S140, and determines whether it has received a response before the measured time (counted value) reaches a predetermined first time-out value (first maximum allowed time) that will be allowed to elapse before the receiving of a response is to take place in steps S150 and S160. Specifically, in step S150, the microcomputer 11 determines whether it has received a response by determining whether it receives a predetermined number of pieces of 8-bit data surrounded by the start and stop bits.

Upon determining that the microcomputer 11 has received a response before the measured time reaches the first time-out value (YES in step S150), the microcomputer 11 receives the response in step S160, returning to step S110 and repeatedly performing the master task from step S110.

In contrast, upon determining that the microcomputer 11 has not received a response (NO in step S150) before the measured time reaches the first time-out value (NO in step S170), the microcomputer 11 returns to step S150, and waits for receiving a response. Otherwise, upon determining that the microcomputer 11 has not received a response (NO in step S150) after the measured time has reached the first time-out value (YES in step S170), or upon determining that the microcomputer 11 has received a response after the measured time has reached the first time-out value (see step S155), the microcomputer 11 determines that there is any error in the target slave 3 and/or on the bus BS, performing a prepared process against the error in step S180, returning to step S110 and repeatedly performing the master task from step S110.

Returning to the determination in step S190, upon determining that there is timing for sending an event header (YES in step S190), the microcomputer 11 transmits the enabling signal EN to the encoder 13, in other words, changes the level of the enabling signal EN from the inactive level to the active level to allow the encoder 13 to output encoded data in step S200. Thereafter, in step S200, the microcomputer 11 sends an event header for checking whether an event occurs in each slave 3.

After the sending of the event header, the microcomputer 11 starts to measure time (for example, sets a hardware or software timer to count up) in step S210, and determines whether it has received an ID before the measured time (counted value) reaches a predetermined second time-out value (second maximum allowed time) that will be allowed to elapse before the receiving of an ID is to take place in steps S220 and S230. For example, in step S220, the microcomputer 11 determines whether it has received an ID by determining whether the UART 11a receives, through the decoder 16, 8-bit data surrounded by the start and stop bits, and the 8-bit data represents an ID.

Upon determining that the microcomputer 11 has received an ID before the measured time reaches the second time-out value (YES in step S220), the microcomputer 11 proceeds to step S140 and performs the operations in step S140 to S170 (S180) for receiving a response.

In contrast, upon determining that the microcomputer 11 has not received an ID (NO in step S220) before the measured time reaches the second time-out value (NO in step S230), the microcomputer 11 returns to step S220, and waits for receiving an ID. Otherwise, upon determining that the microcomputer 11 has not received an ID (NO in step S220) after the measured time has reached the second time-out value (YES in step S230), or upon determining that the microcomputer 11 has received an ID after the measured time has reached the second time-out value (see step S225), the microcomputer 11 determines that no event frames are transmitted from all slaves 3, returning to step S110 and repeatedly performing the master task from step S110.

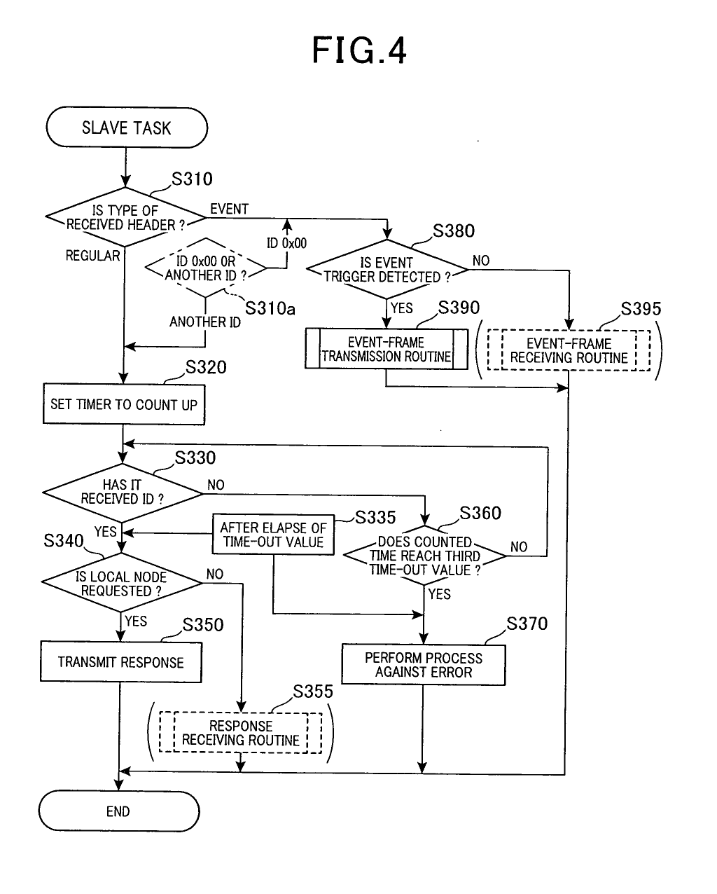

Next, the slave task to be carried out by the microcomputer 11 of each of a slave 3 and the master 1 in accordance with a corresponding slave-task program P2 stored in the microcomputer 11 will be described hereinafter with reference to FIG. 4.

The slave task (slave-task program P2) is launched when receiving a header from the master 11 via the bus BS.

When the slave task is launched, the microcomputer 11 identifies the type of the received header to determine whether the received header is a regular header or an event header in step S310.

Upon determining that the received header is a regular header (“REGULAR” in step S310), the microcomputer 11 starts to measure time (for example, sets a hardware or software timer to count up) in step S320, and determines whether it has received an ID before the measured time (counted value) reaches a predetermined third time-out value (third maximum allowed time) that will be allowed to elapse before the receiving of an ID is to take place in steps S330 and S360. For example, in step S330, the microcomputer 11 determines whether it has received an ID by determining whether the UART 11a receives, through the decoder 16, 8-bit data surrounded by the start and stop bits, and the 8-bit data represents an ID.

Upon determining that the microcomputer 11 has received an ID before the measured time reaches the third time-out value (YES in step S330), the microcomputer 11 determines whether the received ID identifies the ID of the local node (the corresponding slave 3 or master 11) in step S340.

Upon determining that the received ID identifies the ID of the local node (YES in step S340), the microcomputer 11 sends the enabling signal EN to the encoder 13, in other words, changes the level of the enabling signal EN from an inactive level to an active level to allow the encoder 13 to output encoded data in step S350. Thereafter, in step S350, the microcomputer 11 sends the received ID, and successively sends prepared data (a prepared response), terminating the slave task. Otherwise, upon determining that the received ID does not identify the ID of the local node (NO in step S340), the microcomputer 11 sends the received ID as it is, terminating the slave task.

On the other hand, upon determining that the microcomputer 11 has not received an ID (NO in step S330) before the measured time reaches the third time-out value (NO in step S360), the microcomputer 11 returns to step S330, and waits for receiving an ID. Otherwise, upon determining that the microcomputer 11 has not received an ID (NO in step S330) after the measured time has reached the third time-out value (YES in step S360), or upon determining that the microcomputer 11 has received an ID after the measured time has reached the third time-out value (see step S335), the microcomputer 11 determines that there is any error in the master 11 and/or on the bus BS, performing a prepared process against the error in step S370, terminating the slave task.

Returning to the determination in step S310, upon determining that the received header is an event header (“EVENT” in step S310), the microcomputer 11 determines whether there is an event (event trigger) in the local node in step S380. Upon determining that there is not an event in the local node (NO in step S380), the microcomputer 11 terminates the slave task. Otherwise, upon determining that there is an event factor in the local node (YES in step S380), the microcomputer 11 performs an event-frame transmission routine in step S390, terminating the slave task.

Note that the determination of whether there is an event in the local node in step S380 can be carried out based on whether a flag (a trigger flag) is set or not by an alternative task to be executed by the microcomputer 11. For example, if there is an event in the local node, the trigger flag is set by the alternative task.

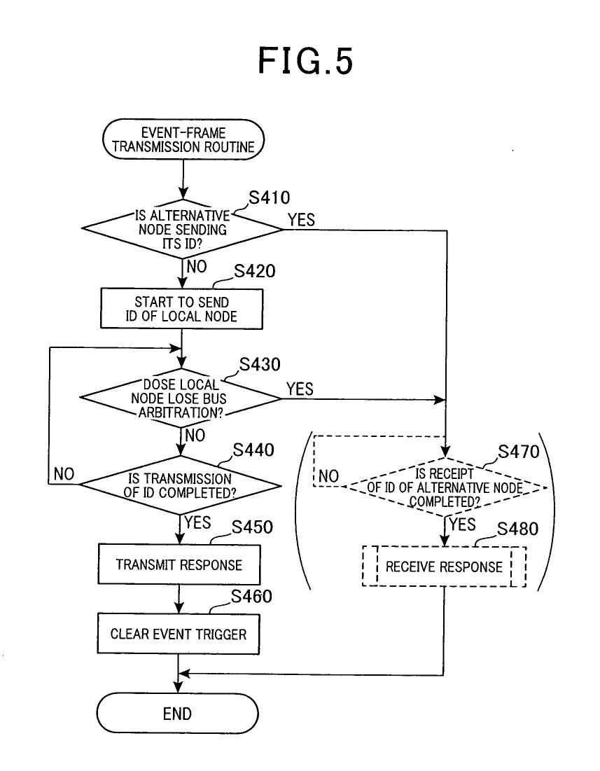

Next, the event-frame transmission routine to be executed by the microcomputer 11 in step S390 will be fully described hereinafter with reference to FIG. 5.

When the event-frame transmission routine is launched in response to the affirmative determination in step S380, the microcomputer 11 determines whether an alternative node is starting transmission of its ID in step S410. Specifically, in step S410, the microcomputer 11 monitors the level on the bus BS via the receive buffer 15 and the decoder 16, and determines that no nodes are sending their IDs as long as the level on the bus BS is the recessive. If the microcomputer 11 is not configured to directly monitor the level on the bus BS, the microcomputer 11 can determine the level on the bus BS based on the level of the collision detection signal CD.

When it is determined that an alternative node is starting transmission of its ID (YES in step S410), the microcomputer 11 terminates the event-frame transmission routine. Otherwise, upon determining that no alternative nodes are starting transmission of their IDs (NO in step S410), the microcomputer 11 transmits the enabling signal EN to the encoder 13, in other words, changes the level of the enabling signal EN from an inactive level to an active level to allow the encoder 13 to output encoded data in step S420. Thereafter, in step S420, the microcomputer 11 starts to send the ID of the local node.

Concurrently with the start of sending the ID of the local node, the microcomputer 11 monitors the level of the collision detection signal CD, and determines whether the local node loses bus arbitration between the ID sent in step S420 and an ID sent from another node simultaneously with the ID sent in step S420 based on whether the collision detection signal CD is changed from the inactive level to the active level in step S430.

Upon determining that the local node loses bus arbitration (YES in step S430), the microcomputer 11 terminates the event-frame transmission routine. At that time, the encoder 13 is disabled to output encoded data because each bit of the transmit data TxD is fixed to the recessive.

Specifically, because the UART 11a cannot stop the transmission of data Tx in the middle of the 8-bit data surrounded by the start and stop bits, the microcomputer 11 stops the output of the encoder 13 to thereby stop the transmission of the ID.

Otherwise, upon determining that the local node wins bus arbitration (NO in step S430), the microcomputer 11 determines whether the transmission of the ID of the local node is completed based on the operating conditions of the UART 11a in step S440. Upon determining that the transmission of the ID of the local node is not completed (NO in step S440), the microcomputer 11 returns to step S430 and continuously monitors the collision detection signal CD.

Otherwise, upon determining that the transmission of the ID of the local node is completed (YES in step S440), the microcomputer 11 sends data (a response) for informing of the occurrence of an event following the ID of the local node in step S450. Thereafter, the microcomputer 11 clears (resets) the trigger flag set to represent that there is an event in the local node in step S460, terminating the event-frame transmission routine.

Note that the slave task including the event-frame transmission routine represents a simple basic task to transmit only a response. If there is a need for a slave 3 to receive a response transmitted from an alternative slave 3, the slave task to be carried by the slave 3 can be configured as follows:

Specifically, if there is a need for a slave 3 to receive a response transmitted from an alternative slave 3, upon determining that the received ID does not identify the ID of the local node (NO in step S340), the microcomputer 11 can perform the operations in steps S140 to S170 (S180) for receiving a response in dashed step S355.

In addition, if there is a need for a slave 3 to receive an event frame transmitted from an alternative slave 3, upon determining that the received header is an event header (“EVENT” in step S310) and that there is not an event in the local node (NO in step S380), the microcomputer 11 can perform an event-frame receiving routine in dashed step S395 corresponding to the operations in steps S220, S230, and S140 to S170 (S180). In addition, upon determining that an alternative node is sending its ID (YES in step S410) or that the local node loses bus arbitration (YES in step S430), the microcomputer 11 can determine whether the receipt of the ID of an alternative node is completed in dashed step S470. Then, upon determining that the transmission of the ID of the alternative node is completed (YES in dashed step S470), the microcomputer 11 can perform a response receiving task in dashed step S480 corresponding to the operation in steps S140 to S170 (S180).

Moreover, if there is no need for the master 1 or a part of slaves 3 to transmit an event frame, the operations in steps S380 and S390 can be omitted from the slave task to be carried out by the master 1 or the part of slaves 3.

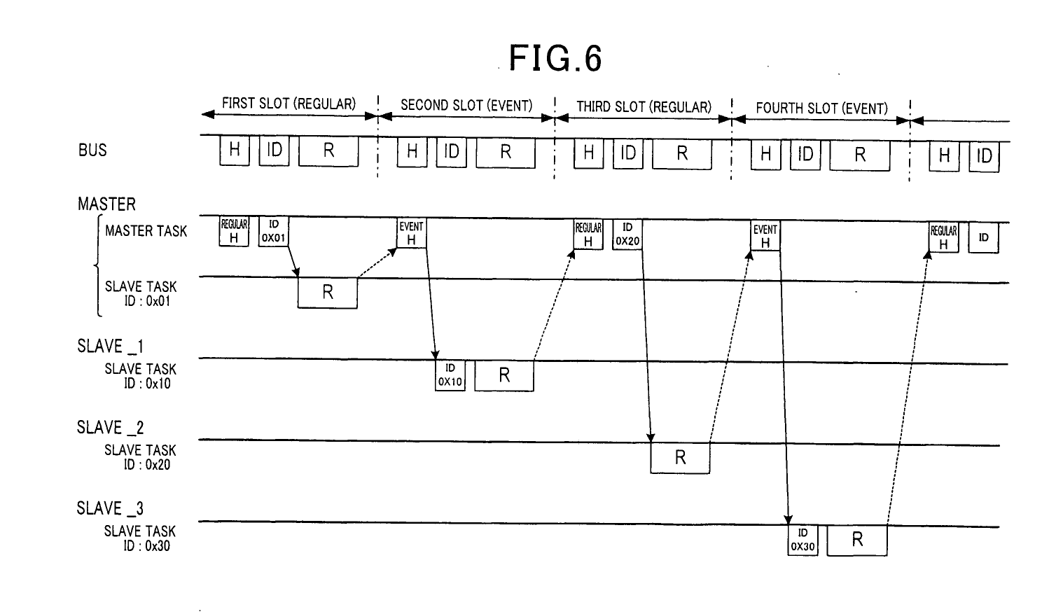

FIG. 6 is a timing chart schematically illustrating basic operations of the communication system according to this embodiment.

Referring to FIG. 6, the master task of the master 1 transmits any one of a regular header (REGULAR H) and an event header (EVENT H) for each slot previously determined (see steps S110, S120, and S190). For example, FIG. 6 shows that a regular frame and an event frame are alternatively transmitted from the master 1. When transmitting a regular header, the master task of the master 1 transmits an ID of a target node following the regular header; the target node is requested by the master 11 to reply a response. The regular header and the ID of the regular frame are successively transmitted to all slaves 3 in a predetermined order defined by the previously established schedule, and thereafter returned to the master 1.

The slave task of the target node of the master 1 identified by the ID following the regular header sends a prepared response “R” subsequent to the received ID (see steps S330 to S370). For example, in FIG. 6, because the master 1 is identified by the ID (0x01: hex 01) of the regular frame in the first slot, the slave task of the master 1 sends a prepared response R subsequent to the received ID. As described above, a response of each regular frame transmitted from a slave 3 or the master 1 is received into the master 1 or a slave 3, which wants to receive it.

If an event header is transmitted by the master task, the slave task of a slave 3 that detects an event trigger successively sends the received event header, its ID, and a prepared response in this order (see steps S380 and S390). For example, when an event header is transmitted from the master 1 in the second slot and a slave _1 as a slave 3 detects an event trigger, the slave _2 successively sends the received event header, its ID (0x10), and a prepared response in this order. A response of each event frame transmitted set forth above is received into the master 1 or a slave 3, which wants to receive it as well as a response of each regular frame.

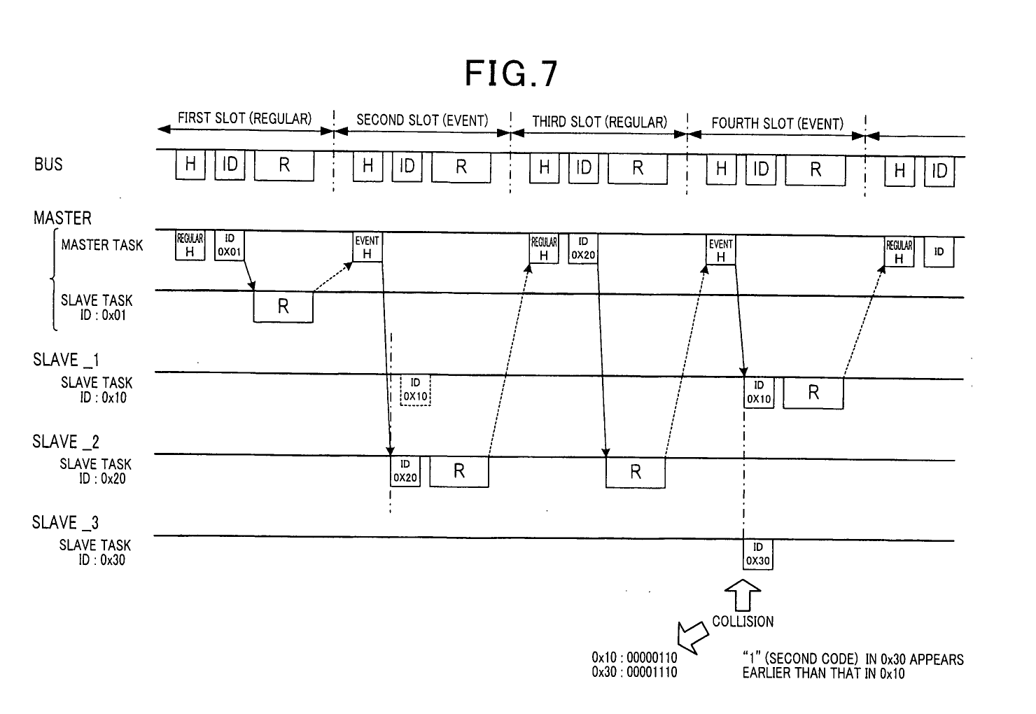

FIG. 7 is a timing chart schematically illustrating operations of the communication system according to this embodiment if some slaves 3 want to transmit their prepared responses in a slot for an event frame.

As illustrated in the second slot in FIG. 7, if each of slaves _1 and _2 as slaves 3 detects an event trigger, when the slave _2 starts to transmit the ID thereof earlier than the slave _1, the slave _1 detects that an alternative node (slave _2) is starting transmission of the ID of the alternative node, and cancels transmission of the ID of the slave _1 (see step S410). Thus, the ID of the slave _2 and a prepared response of the slave _2 are transmitted on the bus BS without any collision on the bus BS.

Specifically, because each node (the master 1 or a slave 3) is configured to communicate with another node through the bus BS using the UART 11a, time taken from receiving a header to transmitting an ID depends on the characteristics of the UART 11a of each node. Thus, there are variations in the time of the individual nodes, which may cause deviations between the transmission timings of the slave _1 and the slave _2.

Particularly, as illustrated in the fourth slot in FIG. 7, if each of slaves _1 and _3 as slaves 3 detects an event trigger, when the slave _1 and the slave _3 simultaneously transmit their IDs, there is a collision between the ID (0x10) of the slave _1 and the ID (0x30) of the slave _3 on the bus BS.

Specifically, the ID (0x10) of the slave _1 can be represented as 8-bit binary data of 00000110, and the ID (0x30) of the slave _3 can be represented as 8-bit binary data of 00001110. When the slave _1 and the slave _3 simultaneously transmit their IDs (00000110 and 00001110), because the first to fourth bits are all 0 (dominants), the same first codes corresponding to the dominants are simultaneously transmitted on the bus BS from the slave _1 and _3.

Because the ID (0x30) of the slave _3 is greater than the ID (0x10) of the slave _1, the recessive (1) appears in the ID of the slave _3 earlier than in the ID of the slave _1. That is, when the slave _1 and the slave _3 simultaneously transmit the fifth bit on the bus BS, because the fifth bit of the ID (0x30) is 1 (recessive) whereas the fifth bit of the ID (0x10) is 0 (dominant), the second code corresponding to the recessive and the first code corresponding to the dominant are simultaneously transmitted on the bus BS so that arbitration between the first code and the second code occurs on the bus BS.

As described above, because the dominant wins arbitration on the bus BS upon collision between the dominant and the recessive, the second and third recessives of the second code lose arbitration on the bus BS (see step S430) so that they are changed to the dominants (see (c) of FIG. 2). This results in that the second code transmitted from the slave _3 is changed to the first code on the bus BS.

At that time, the arbiter 17 detects the mismatching between the second code of the fifth bit of the transmitted ID and the first code on the bus BS monitored through the receive buffer 15, thus changes the level of the collision detection signal CD from the inactive level to the active level. This results in that the microcomputer 11 of the slave _3 disables the encoder 13 to output encoded data to stop the output of the encoder 13, thus stopping the transmission of the ID and a prepared response. Thus, a response of the slave _1 is only transmitted on the bus BS without being unchanged.

As described above, the communication system according to the first embodiment is configured such that each slave 3 determines whether there is timing for starting the passive communication mode using a regular frame or timing for starting the active communication mode using an event frame based on a header sent from the master 1. This configuration eliminates the need of communications between the master 1 and the slaves 3 using specific frames for switching between the passive communication mode and the active communication mode. Thus, if there is an event in a slave 3, the slave 3 can immediately inform the master 1 and/or another slave 3 of the occurrence of the event without waiting for data sending timing of a regular frame according to the previously established schedule.

In addition, the communication system according to the first embodiment is configured such that, if a plurality of slaves 3 request to transmit data in the active communication mode, one of the plurality of slaves 3, which starts to transmit its ID earliest in the plurality of slaves 3, is enabled to transmit a response. In this case, if the plurality of slaves 3 simultaneously transmit their IDs, the communication system is further configured to arbitrate the IDs on the bus BS, and enables one of the plurality of slaves 3 to transmit a response; the one of the plurality of slaves 3 wins the arbitration on the bus BS. Thus, it is possible to efficiently transmit event frames without the master 1 sending, in the following slots, headers to the plurality of slaves 3.

The communication system according to the first embodiment is configured such that the ID sending timings of slaves 3 are uncontrolled intentionally. However, priorities can be set on responses of slaves 3, and the slave task can be configured to transmit their IDs at plural timings based on the priorities of corresponding subsequent responses. That is, in step S420, the slave task can be configured to transmit its ID, which corresponds to a first response, earlier than its ID, which corresponds to a second response; the first response is higher in priority than the second response.

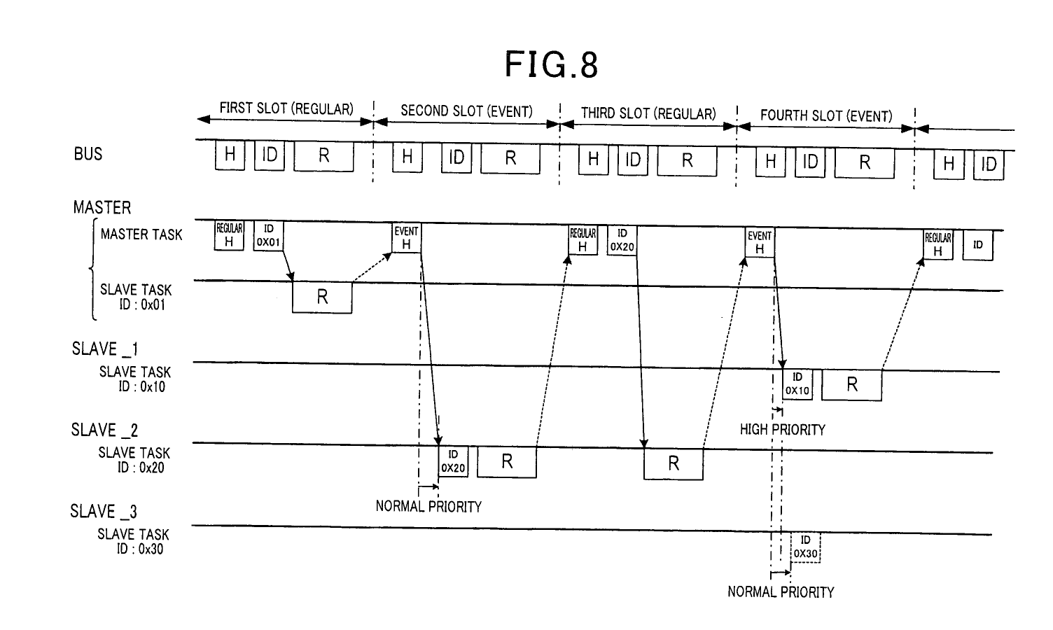

FIG. 8 is a timing chart schematically illustrating operations of the communication system according to a modification of the first embodiment when responses of the slave 2 and the slave _3 are set to normal priorities, and responses of the slave _1 are set to high priorities higher than the normal priorities.

In each slot for transmitting an event frame, the slave task of each slave 3 is configured to transmit its ID at a timing defined based on the priority of a corresponding subsequent response. For example, as illustrated in FIG. 8, when the slave _1 and the slave _3 want to transmit their IDs in the same forth slot, the ID transmitting timing of the slave _1 is set to be earlier than that of the slave _3 because responses of the slave _1 are higher in priority than those of the slave _3. Thus, a response of the slave _1 is only transmitted on the bus BS (see YES in step S410).

### Second Embodiment

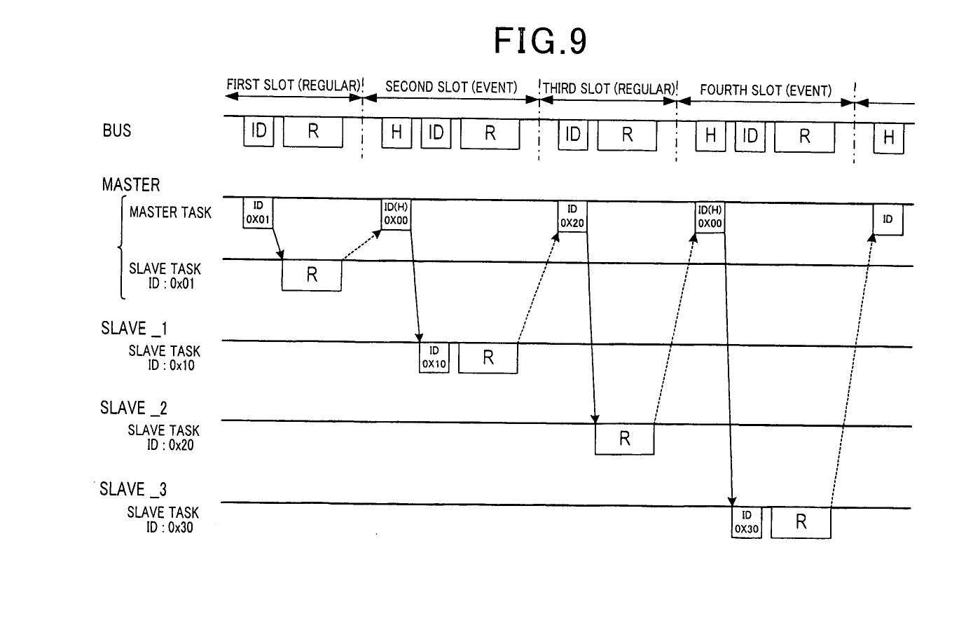

A communication system according to a second embodiment of the present disclosure will be described with reference to FIG. 9. The overall structure and functions of the communication system according to the second embodiment are substantially identical to those of the communication system according to the first embodiment except for the following points. Therefore, the different points will be mainly described hereinafter.

The first different point is that the format of regular frames according to the second embodiment is different from that of regular frames according to the first embodiment. The second different point is that each of the master task and the slave task according to the second embodiment is slightly different from a corresponding one of the master task and the slave task according to the first embodiment.

FIG. 9 is a timing chart schematically illustrating an example of the structure of frames to be used for data communications of the communication system according to the second embodiment, and basic operations of the communication system according to the second embodiment.

Referring to FIG. 9, an event frame according to the second embodiment is comprised of a header, an ID, and a response as well as the first embodiment. On the other hand, a regular frame according to the second embodiment is comprised of an ID and a response, from which an header is omitted.

Specifically, an event header of an event frame according to the second embodiment represents the transmitting timing of the corresponding event frame. For example, the event header of an event frame according to the second embodiment is an ID of 0x00 as identification information.

That is, when receiving the ID of 0x00 as the head portion of a frame, the slave task identifies that the received frame is an event frame. Otherwise, when receiving an ID different from the ID of 0x00 as the head portion of a frame, the slave task identifies that the received frame is a regular frame. Thus, it is possible to eliminate the header of each regular frame.

The master task according to the second embodiment is configured to perform the operations in steps S110 to S180 of FIG. 3 while skipping the operation in step S120.

The slave task according to the second embodiment is configured to perform the operations in steps S320 to S370 of FIG. 4 while skipping the operations in steps S320, S330, S335, S360, and S370. In place of the operation in step S310 of FIG. 4, the slave task is configured to determine whether received data of a frame sent from the master 1 is the ID of 0x00 (event header) or another ID in step S310a of FIG. 4.

Upon determining that the received data is another ID (“ANOTHER ID” in step S310a), the slave task determines that the received data is the ID of a regular frame, proceeding to step S340. Otherwise, upon determining that the received data is the ID of 0x00 (“ID 0x00” in step S310a), the slave task determines that the received ID is the event header of an event frame, proceeding to step S380.

As described above, the communication system according to the second embodiment is configured to achieve an advantage of reducing the length of each regular frame in addition to the advantages achieved by the communication system according to the first embodiment, more improving communication efficiency on the bus BS.

The first and second embodiments of the present disclosure have been fully described, but the present disclosure is not limited to the first and second embodiments, and can be modified or deformed within the scope thereof.

For example, in each of the first and second embodiments, the communication system is applied as a communication system for vehicles, but can be applied as a communication system that needs to implement both the passive and active communication modes. In each of the first and second embodiments, using the encoder 13 and decoder 16 allows PWM-code data to be transmitted on the bus BS, but eliminating the encoder 13 and decoder 16 from each node allows NRZ-code data to be transmitted on the bus BS.

Note that, in each of the first and second embodiments, a header for example corresponds to information indicative of start of an active communication mode, an ID of a regular frame for example corresponds to designation of one of a plurality of slave nodes, and an ID of an event frame for example corresponds to information requesting active transmission of data required to be transmitted in the active communication mode upon a corresponding slave node having the data.

For example, the operations in steps S120 and S130 correspond to a first transmitting unit, the operation in step S200 corresponds to a second transmitting unit, the operations in steps S110 and S190 correspond to a switching unit, the operation in step S310 corresponds to a receiving unit and a determining unit, the operations in steps S380 and S390 (S410 to S480) correspond to a first transmitting unit, a bus monitoring unit, and a second transmitting unit, and the operations in steps S320 to S350 correspond to a third transmitting unit.

While illustrative embodiments of the present disclosure has been described herein, the present disclosure is not limited to the embodiments described herein, but includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be constructed as non-exclusive.

What is claimed is:

1. A communication system comprising: a bus; a master node; and a plurality of slave nodes communicably coupled to the master node through the bus, the master node being configured to:
transmit any one of: first information indicative of start of an active communication mode; and second information including at least designation of one of the plurality of slave nodes as a target slave node requested to send data in a passive communication mode,
each of the plurality of slave nodes being configured to:
receive any one of the first information and second information transmitted from the master node;
determine whether the active communication mode or the passive communication mode is started based on any one of the first information and second information received thereby;
transmit the first information and third information subsequent to the first information when it is determined that the active communication mode is started based on the first information received thereby, the third information requesting active transmission of data required to be transmitted in the active communication mode upon a corresponding slave node having the data;
transmit the data subsequent to the third information when the corresponding slave node wins arbitration on the bus between the third information transmitted from the corresponding slave node and the third information transmitted from an alternative slave node in the plurality of slave nodes upon the third information being transmitted from the alternative slave node; and
transmit the designation and data subsequent to the designation when it is determined that the passive communication mode is started based on the second information received thereby and the designation designates the corresponding slave node as the target node.

2. The communication system according to claim 1, wherein the master node is configured to transmit the second information including a set of start of the passive communication mode and the designation of one of the plurality of slave nodes as the target slave node in the passive communication mode.

3. The communication system according to claim 1, wherein the first information is designation of the start of the active communication mode, and the master node is configured to transmit the second information including only the designation of one of the plurality of slave nodes as the target slave node in the passive communication mode.

4. The communication system according to claim 1, wherein the arbitration on the bus between the third information transmitted from the corresponding slave node and the third information transmitted from the alternative slave node is configured such that one of the corresponding slave node and the alternative slave node wins when the one of the corresponding slave node and the alternative slave node starts to transmit the third information earlier than the other thereof.

5. The communication system according to claim 4, wherein the data to be transmitted from each of the plurality of slave nodes is pieces of data, priorities are set on the pieces of the data, and each of the plurality of slave nodes is configured such that, the higher the priority of a piece of the data is, the earlier the third information corresponding to the piece of the data is.

6. The communication system according to claim 1, wherein the bus allows a bit with an electrical dominant level to be asserted thereon in priority to a bit with an electrical recessive level different from the electrical dominant level, the third information is comprised of a train of bits, the bits being comprised of at least one the dominant level and at least one the recessive level, and the arbitration on the bus between the third information transmitted from the corresponding slave node and the third information transmitted from the alternative slave node is configured such that one of the corresponding slave node and the alternative slave node wins when the train of bits as the third information transmitted from the one of the corresponding slave node and the alternative slave node remains unchanged in comparison to the train of bits as the third information transmitted from the other thereof.

7. A master node communicably coupled to a plurality of slave nodes through a bus, the master node comprising:
a first transmitting unit configured to transmit first information indicative of start of an active communication mode for requesting at least one of the plurality of slave nodes to actively transmit data upon the at least one of the plurality of slave nodes having the data;
a second transmitting unit configured to transmit second information including at least designation of one of the plurality of slave nodes as a target slave node requested to send data in a passive communication mode; and
an activating unit configured to switchably activate any one of the first and second transmitting units in accordance with a previously established schedule.

8. The master node according to claim 7, wherein the second transmitting unit is configured to transmit the second information including a set of start of the passive communication mode and the designation of one of the plurality of slave nodes as the target slave node in the passive communication mode.

9. The master node according to claim 7, wherein the first information is designation of the start of the active communication mode, and the second transmitting unit is configured to transmit the second information including only the designation of one of the plurality of slave nodes as the target slave node in the passive communication mode.

10. A slave node communicably coupled to a master node through a bus, the slave node comprising:
a receiving unit configured to, when any one of first information indicative of start of an active communication mode and second information including at least designation of the slave node as a target slave node requested to send data in a passive communication mode is transmitted, receive any one of the first information and the second information transmitted from the master node;
a determining unit configured to determine whether the active communication mode or the passive communication mode is started based on any one of the first information and second information received by the receiving unit;
a first transmitting unit configured to transmit the first information and third information subsequent to the first information when it is determined that the active communication mode is started based on the first information received by the receiving unit, the third information requesting active transmission of data required to be transmitted in the active communication mode upon the slave node having the data;
a bus monitoring unit configured to monitor arbitration on the bus;
a second transmitting unit configured to transmit the data subsequent to the third information when the slave node wins the arbitration on the bus between the third information transmitted from the slave node and another information transmitted from another slave node communicably coupled to the master node based on a result of the monitor by the bus monitoring unit; and
a third transmitting unit configured to transmit the designation and data subsequent to the designation when it is determined that the passive communication mode is started based on the second information received by the receiving unit and the designation designates the slave node as the target node.

11. The slave node according to claim 10, wherein the receiving unit is configured to receive the second information including a set of start of the passive communication mode and the designation of the slave node as the target slave node in the passive communication mode.
